(19) United States
(12) Patent Application Publication
(10) Pub. No.: US 2005/0255753 A1
(43) Pub. Date: Nov. 17, 2005

(54) Ultra thin sim card reading device for a communications device, in particular for a mobile telephone

(76) Inventor: Ulrich Buschmann, Elchingen (DE)

Correspondence Address: PERMAN & GREEN, 425 POST ROAD, FAIRFIELD, CT, 06824, US

(21) Appl. No.: 10/499,083

(22) PCT Filed: Dec. 21, 2001
(86) PCT No.: PCT/EP01/15215

§ 371 Date: May 13, 2005

(51) Int. Cl. H01R 24/00

(52) U.S. Cl. 439/630

(57) ABSTRACT

The present invention relates to a SIM card reading device comprising a SIM contact pad (36) mounted on a printed wire board (37) that is arranged in a housing (14) of a communications device, in particular of a mobile telephone, and SIM card holder (10) arranged in the housing of the communications device for accommodating a SIM card and holding it in contact with the SIM contact pad. To provide a new SIM card reading device that facilitates inserting and removing a SIM card into and from the communications devices although it is very thin to minimize the thickness of communications devices and in particular of mobile telephones, the SIM card holder (10) comprises a flat plate (11) for placing a SIM card thereon, mounting means (23) attached thereto for pivotally mounting the flat plate (14) in the housing (14) so that the plate (11) can be pivoted from a first position for placing a SIM card to be inserted into the communications device thereon into a second position for holding elements (20, 21, 22) attached to the plate (11) for holding a SIM card placed on the plate in place, and interlocking means (30) attached to the plate (11) for locking the SIM card holder (10) in the second position.

The present invention relates to an ultra thin SIM card reading device for a communications device, in particular for a mobile telephone.

### BACKGROUND OF THE INVENTION

Electromechanical and mechanical components of a SIM (subscriber identification module) card reading device with their characteristic dimensions influence the thickness of communication devices and in particular the thickness of mobile telephones. In a SIM card reading device the holding and releasing mechanism for a SIM card is an important part of it. The dimensions of the SIM card with its contacting area and the dimensions of functional elements like hinges, actuators, as well as click and spring elements increase thickness.

Although, there is a need to reduce the overall dimensions of communications devices, in particular of mobile telephones, conventional SIM card reading devices are a bar for further decreasing the thickness of communications devices that can be operated only when a SIM card is inserted.

### SUMMARY OF THE INVENTION

Accordingly, it is an object of the present invention to provide a new SIM card reading device for a communications devices that facilitates inserting and removing a SIM card into and from the communications devices although it is very thin to minimize the thickness of communications devices and in particular-of mobile telephones.

This object is accomplished by a SIM card reading device according to claim 1. Refinements and developments of the present invention are described in the dependent claims.

According to the present invention all functional elements of the SIM card reading device that would increase the thickness have been removed from the region beneath the battery. In addition, a standard SIM contact pad has been chosen with focus on thickness, so that placement beneath the SIM card would be possible to use the volume of the communications device optimally and to save precious placement area on the printed wire board (PWB).

In more detail, according to present invention the SIM card holder of a SIM card reading device comprises a flat plate for placing a SIM card thereon, mounting means attached thereto for pivotally mounting the flat plate in the housing so that the plate can be pivoted from a first position for placing a SIM card to be inserted into the communications device thereon into a second position for holding the SIM card in contact with the SIM contact pad, and vice versa, holding elements attached to the plate for holding a SIM card placed on the plate in place, and interlocking means attached to the plate for locking the SIM card holder in the second position.

To protect a SIM card held in a communications device against direct radio frequency (RF) irradiation, the flat plate is formed from sheet metal and comprises a contact tongue for connecting the plate to a contact element. Thus, it is easily possible to keep the plate at a determined potential, e.g. at ground potential for screening the SIM card and therefore to comply with the requirement of the electromagnetic compatibility (EMC).

According to a preferred development of the invention the flat plate, the mounting means, holding elements, and interlocking means are made of one piece of sheet metal by punching and bending. Therefore, the production of the inventive SIM card reading device can be simplified.

Further, using reliable sheet metal technology makes it possible to get a stiff and robust SIM card holder the flat plate of which is provided with at least one side wall projecting therefrom substantially perpendicularly to the main plane of the plate and extending in parallel and adjacent to a pivot axis defined by the mounting means, the side wall forms an abutting element for a SIM card placed on the plate.

To provide additional shape reinforcements the flat plate is provided with three side walls two of which extending in parallel to each other and substantially perpendicularly to the pivot axis defined by the mounting means, wherein the holding elements for the SIM card are formed by hooks attached to the side walls.

According to another preferred refinement of the invention, the mounting means are formed by lobes each provided with a hole to receive a pivot pin, wherein the holes of the lobes are arranged in such a way the pivot axis defined thereby when mounted on pivot pins is substantially in alignment with an edge of the plate that is provided with a side wall. Therefore, the SIM card reading device can handled with ease since the SIM card holder thereof have to be only rotated so that no slide-turn actions are necessary.

According to another advantageous refinement of the invention, the interlocking means is formed by a snap-fit locking element, in particular a snap-hook that is biased by spring element into an intermediate locking position, wherei the spring element is arranged substantially perpendicularly to the plate at the side opposite to that adjacent to the pivot axis.

To ensure that the integrated spring element can act as shock absorber when the communications device drops, the snap-hook can be moved against the force of the spring element from its intermediate locking position into a blocked locking position located remote from the plate and into a releasing position located adjacent to the plate. Thus, the spring element of the SIM card reading device can be displaced from its intermediate interlocking position by a bottom side of a battery pack placed in the housing of the communications device. Consequently, the spring element will push the battery pack into a defined position so that resilient battery connector contacts can be optimized, since they need to have only a reduced stroke. On the other hand the battery pack forces the snap-hook in a blocked interlocking position so that it cannot be manipulated to release SIM card holder, nor it will declench when the communications device drops.

To make the handling of the inventive SIM card reader much easier, the snap-hook is provided with a tab for moving it into its releasing position.

### BRIEF DESCRIPTION OF THE DRAWINGS

The invention will be explained in more detail hereinafter with reference to the accompanying drawings.

FIG. 1 shows a perspective view of a SIM card holder of a SIM card reading device according to the present invention;

FIG. 2 shows a sectional side view of the SIM card holder of FIG. 1 mounted in a housing element of a communications device;

FIG. 3 shows a perspective view of the SIM card holder of FIG. 1 mounted in a communications device, wherein the SIM card holder is in a position for inserting and removing a SIM card;

FIG. 4 shows a perspective view of the SIM card holder of FIG. 1 mounted in a communications device, wherein the SIM card holder is in a position for holding a SIM card in contact with a SIM contact pad;

FIG. 5 shows a plan view of the SIM card holder mounted in a communications device and arranged in the position illustrated in FIG. 4;

FIGS. 6a shows a sectional view of a part of the SIM card holder substantially along line VI-VI in FIG. 5 to illustrate the interlocking action between a snap-fit locking element and a shoulder of a housing element of the communications device; and

FIGS. 6b shows sectional view of a part of the SIM card holder similar to that of FIG. 6a to illustrate the interaction between an inserted battery pack and the snap-fit locking element in its interlocking position.

Mutually corresponding components arc provided with the same reference symbols in the various figures of the drawings.

### DETAILED DESCRIPTION OF A PREFERRED EMBODIMENT

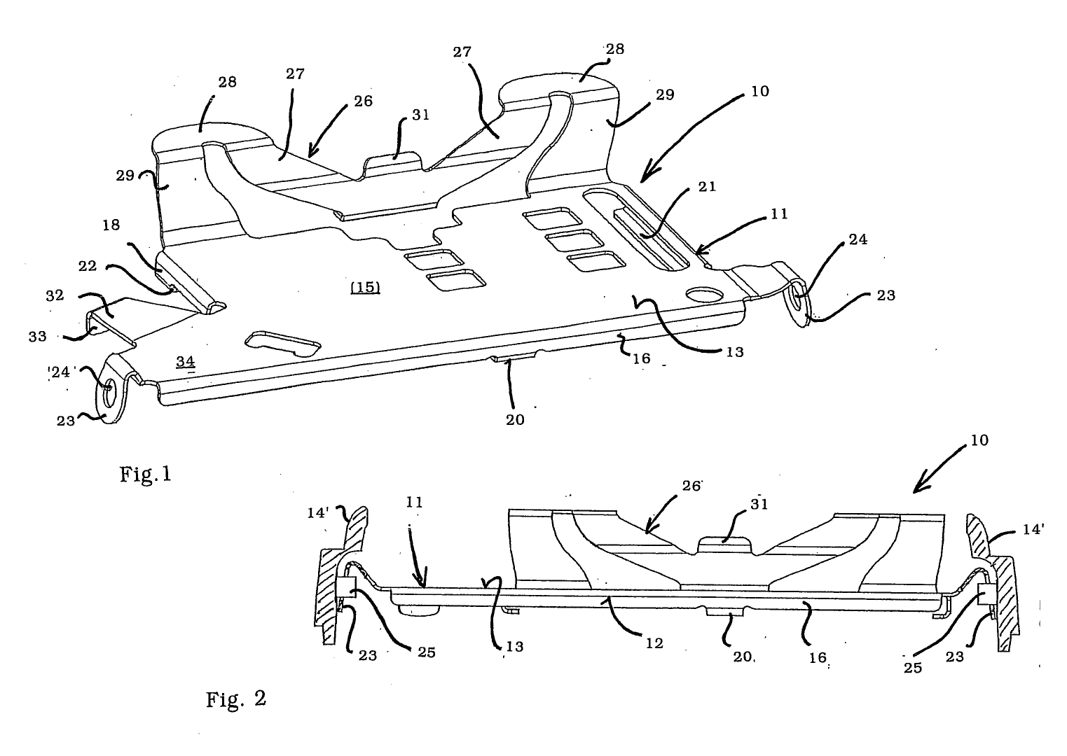

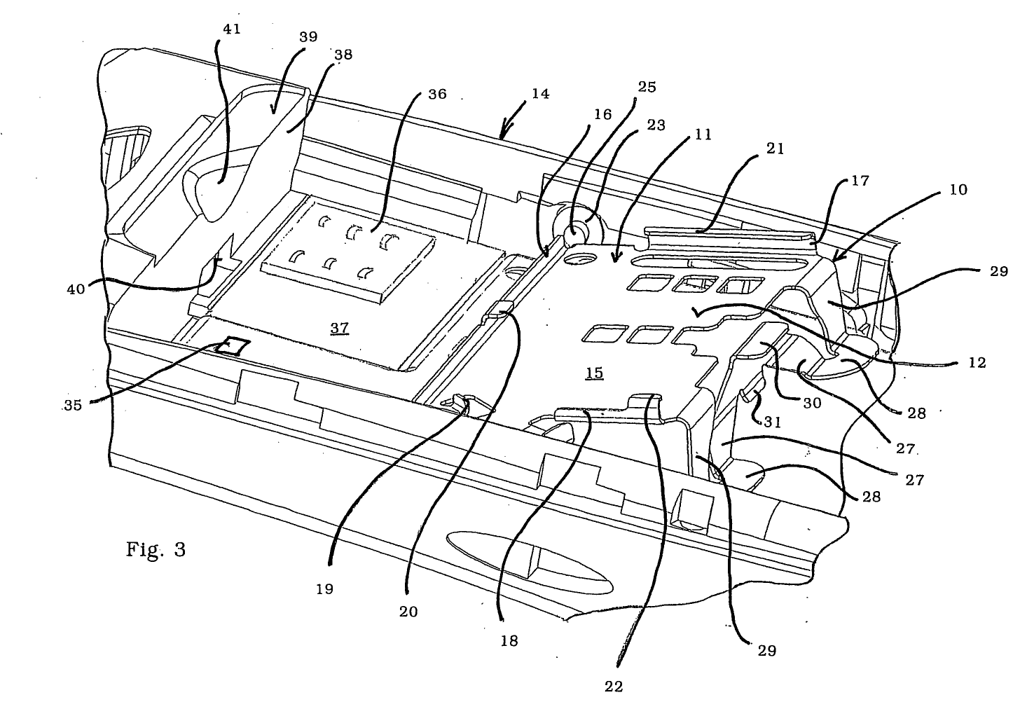

As shown in FIGS. 1, 2 and 3 a SIM card holder 10 of the SIM card reading device according to the present invention comprises a flat plate 11 having a first and a second main surface 12 and 13 provided on opposite sides of the flat plate 11. As can be best seen in FIG. 3, that shows the SIM card holder 10 mounted in a housing 14 of a communications device, in particular, of a mobile telephone, the first main surface 12 has a SIM card holding portion 15 that is defined by first, second and third side walls 16, 17, 18 and by a stop element 19 that is associated with the oblique edge of a SIM card to ensure that a SIM card can be only placed completely in the SIM card holding portion 15 when it is correctly oriented relative to the SIM card holder 10. Whereas the second and third side walls 17, 18 form guiding elements with regard to inserting and removing the SIM card into and from the SIM card holder 10, all side walls act as holding elements that prevent a movement of the SIM card in the plane thereof. To keep a SIM card in the SIM card holding portion 15 holding elements formed as hooks 20, 21, 22 are attached to the side walls 16, 17, 18. Thus, a SIM card placed in the holding portion 15 cannot be lifted up from the first main surface 12.

In the drawings three hooks 20, 21, 22 are shown as holding elements to secure a SIM card in the SIM card holding portion 15 of the SIM card holder 10. However, it is also possible to provide hooks or other similar holding elements only on two sides of the SIM card holding portion 15 as long as the holding elements support a SIM card at three points that define a triangle. E.g., in the present case it would be possible to omit the hook 20 so that a SIM card would be held in the SIM card holding portion 15 only by the side walls 16, 17, 18 and the hooks 21, 22. This could be done since the hook 21 extends along the whole length of the side wall 17 so that the end portions of the hook 21 define together with the hook 22 the necessary supporting triangle for a SIM card.

The side walls 16, 17, 18 are integrally formed with the flat plate 11 and are bent in such a way that they project substantially perpendicularly to the first main surface and extend along edge portions of the flat plate 11. Therefore, the side walls 16, 17, 18 are not only guiding and holding elements for a SIM card to be placed in the holding portion but also reinforcement elements to improve the stiffness and robustness of the SIM card holder 10. For the same purpose the hook 21 provided at the second side wall 17 extends along the whole length of the side wall further improving the stiffness of the flat plate 11.

As can be seen best in FIGS. 1 and 2 the SIM card holder 10 is provided with mounting means 23 for mounting the SIM card holder 10 in the housing 14 of the mobile telephone. The mounting means are formed by lobes 23 each having a hole 24 to receive a pivot pin 25 provided on a frame element 14′ of the housing 14. The holes 24 in the lobes 23 define a pivot axis that extends in parallel with that edge of the flat plate 11 that is formed by the bending portion between the flat plate 11 and the first side wall 16. In particular, the pivot axis substantially coincides with this edge of the flat plate 11 and the side wall 16.

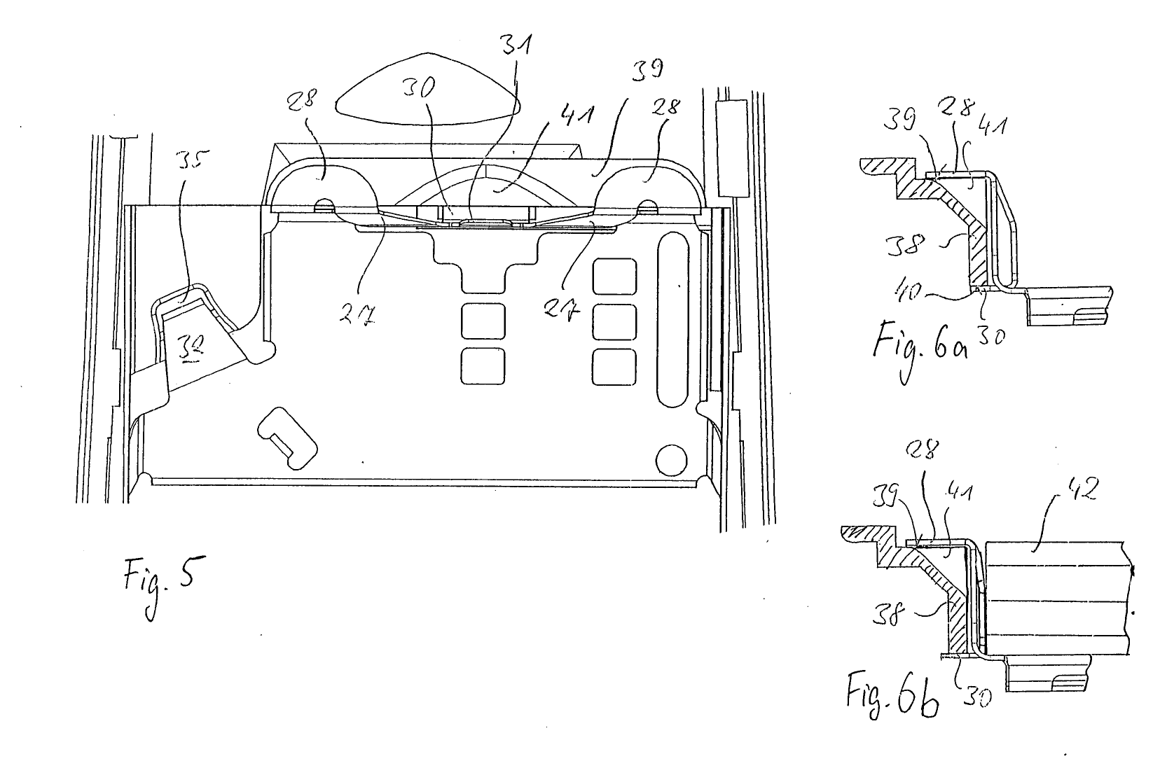

A spring element 26 having two spring arms 27 is attached with its spring arms 27 to lobe elements 28 that are further attached to supporting stripes 29 that are projecting from the second main surface 13 of the flat plate 11 substantially perpendicularly thereto. The spring arms 27 which are arranged in a substantial V-shaped manner are commonly provided with a snap-hook 30 that is substantially in alignment with the flat plate 11 as can be best seen in FIGS. 6a and 6b. Two manually move the snap-hook from its intermediate locking position into a releasing position the central portion of the spring element if provided with a tap 31.

At least, a contact tongue 32 with a contact hook 33 is attached to a contact mounting portion 34 of the flat plate 11 so that the plate 11 can be brought in contact with a opposing contact element 35 to keep the SIM card holder 10 at a certain potential, e.g. at ground potential.

The SIM card holder 10 of the SIM card reading device is preferably formed by one piece of sheet metal by punching and bending. In particular, using reliable sheet metal technologies it is possible to provide a stiff SIM card holder that is ultra thin but can be used as a shock absorbing element in a telecommunications device, in particular in a mobile telephone.

As can be best seen in FIG. 3 the SIM card holder 10 described above is pivotally mounted in a housing 14 of a mobile telephone to be a SIM card handling element of the SIM card reading device that comprises a conventional SIM contact pad 36 that is mounted on a printed wire board 37 in a conventional way.

Adjacent to one side of the SIM contact pad 36 opposite to that side facing the pivot axis of the SIM card holder 10 a holding element 38 of the housing 14 is provided for supporting the SIM card holder 10. This holding element 38 comprises an upper shoulder 39 for supporting the lobe elements 28 of the SIM card holder 10 and a lower shoulder 40 for cooperating with the snap-hook 30. The terms “upper” and “lower” referring to the position of the communications device shown in the drawings, are used only for ease of description and do not be related with the orientation of the device during its normal use.

The different functions of the SIM card holder 10 of the reading device will now be explained in more detail with reference to the FIGS. 3 to 6b.

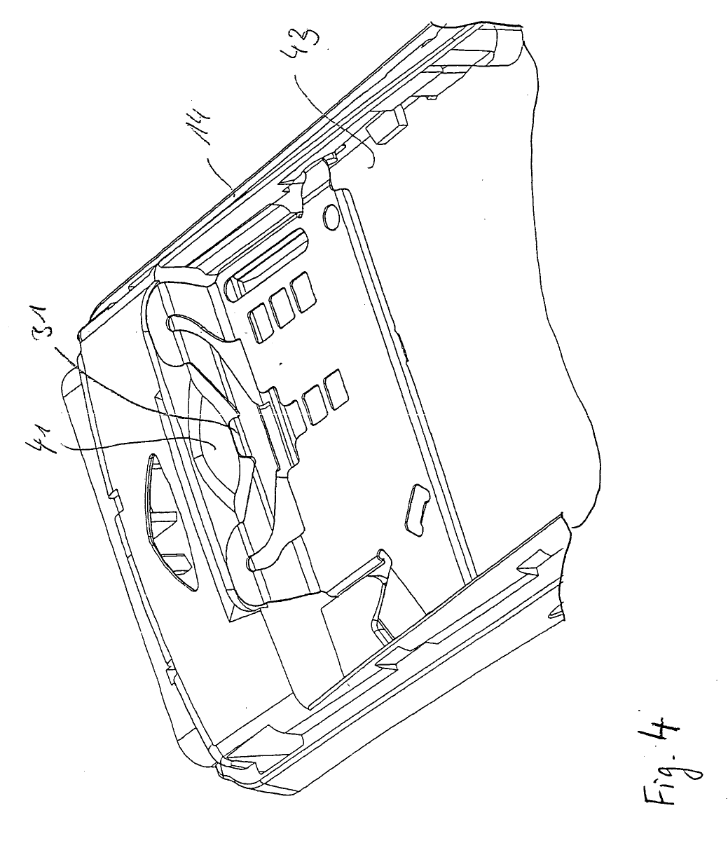

For inserting a SIM card into a mobile telephone a battery pack 42 is removed from the housing 14 of the mobile telephone so that the battery pack compartment 43 is empty as shown in FIG. 4. Thus, the tap 31 for operating the spring element 26 can be actuated by a user to move the snap-hook 30 into its releasing position so that the SIM card holder 10 can be pivoted from its normal operating position shown in FIGS. 4, 5, 6a and 6b into the position shown in FIG. 3 suitable for inserting a SIM card (not shown) into the SIM card holder 10 by placing it onto the SIM card holding portion 15.

After a SIM card is inserted into a SIM card holder so that it is held by the side walls 16, 17, 18, the hooks 20, 21, 22 and the stop element 19, the SIM card holder can be pivoted around the pivot axis defined by the holes 24 of the lobes 23 and pivot pins 25 back into the normal operating position in which the SIM card is held with its contacts in contact with the respective contact elements of the SIM contact pad 36.

During pivoting the SIM card holder 10 into its normal operating position the snap-hook 30 engages the slope of a recess 41 of the holding element 38 so that the snap-hook 30 is forced into its releasing position by the holding element 38 when it is pushed further after contacting the slope of the recess 41. As can be seen best in FIG. 6a the snap hook 30 snaps under the lower shoulder 40 into its intermediate interlocking position when the lobe elements 28 abbot against the upper shoulder 39 of the holding element 38. Thus, the SIM card is fixly hold in contact with the SIM contact pad 36 for normal operation of the mobile telephone.

Simultaneously, the contact hook 33 of the contact tongue 32 is brought in resilient contact with a contact element 35 of the mobile telephone.

Thereafter, the battery pack 43 can be put into the battery pack compartment 43 as indicated in FIG. 6b. The battery pack 42 forces the snap-hook 30 against the spring force of the spring element 26 into a blocked interlocking position shown in FIG. 6b. Consequently, a resilient force is acted on the battery pack 43 that pushes the battery pack against the connector contact elements provided at the opposite end of the battery pack 42. Therefore, the resilient forces for keeping battery contacts in electrical contact with the respective connector contact elements of the mobile telephone are obtained not only by the connector contact elements of the mobile telephone but also by the spring element 26 of the interlocking means for holding the SIM card holder 10 in its normal operating position.

Consequently, the resilient connector contact elements provided at the mobile telephone for connecting the battery pack 42 to the circuitries of the mobile telephone can be minimized since they do not need to provide the whole contact force.

Another advantage of the cooperation between the SIM card holder 10 and the battery pack 42 is that after inserting the battery pack 42 into the battery compartment 43 the snap-hook 30 is held in its blocked interlocking position so that it is not possible to declench the snap-hook 30 from the lower shoulder of the holding element 38 even if the mobile telephone drops. In addition, the spring element acts as a shock absorbing element and prevents the battery pack 42 from hardly hitting against the holding element 38. Thus, the shock resistance of the mobile telephone in which the inventive SIM card reading device is integrated can be improved.

According to the present invention a SIM card reading device is provided that includes a SIM contact pad 36 that is soldered onto a printed wire board 37 in a usual way. A SIM card holder 10 having lateral lobes 23 with holes 24 therein is mounted with the lobes 23 onto pivot pins 25 which are injection molded together with a frame element 14′ of the housing 14. The pivot pins 26 and the lobes 23 forms a hinge around which the SIM card holder 10 can turn. Three hocks 20, 21, 22 provided on three side walls 16, 17, 18 hold a SIM card (not shown) in the contact position. The snap-hook 30 hooks under the lower shoulder 40 of the holding element 38 of the housing 14 when the SIM card holder 10 is brought into it is normal operating or working position. The overlap between the snap hook 30 and the lower shoulder 40 will be increased by approximately 0.5 nm when the snap hook 30 is forced from its intermediate interlocking position into its blocked interlocking position by the battery pack when it is inserted. The spring element 26 will absorb drop energy and will push the battery pack 42 to the connector side as described above.

1. A SIM card reading device comprising a SIM contact pad (36) mounted on a printed wire board (37) that is arranged in a housing (14) of a communications device, in particular of a mobile telephone, and SIM card holder (10) arranged in the housing of the communications device for accommodating a SIM card and holding it in contact with the SIM contact pad,
characterized in that the SIM card holder comprises
a flat plate (11) for placing a SIM card thereon,
mounting means (23) attached thereto for pivotally mounting the flat plate (11) in the housing so that the plate can be pivoted from a first position for placing a SIM card to be inserted into the communications device thereon into a second position for holding the SIM card in contact with the SIM contact pad (36), and vice versa,
holding elements (20, 21, 22) attached to the plate (11) for holding a SIM card placed on the plate in place, and
interlocking means (30) attached to the plate for locking the SIM card holder in the second position.

2. The SIM card reading device as claimed in claim 1, characterized in that the flat plate (11) is formed from sheet metal and comprises a contact tongue (32) for connecting the plate to a contact element (35).

3. The SIM card reading device as claimed in claim 1, characterized in that the flat Plate (11), the mounting means (23), holding elements (20-22), and interlocking means (30) are made of one piece of sheet metal by punching and bending.

4. The SIM card reading device as claimed in claim 1, characterized in that the flat plate (11) is provided with at least one side wall (16) projecting therefrom substantially perpendicularly to the main plane and extending in parallel and adjacent to a pivot axis defined by the mounting means (23), the side wall forms an abutting element for a SIM card placed on the plate.

5. The SIM card reading device as claimed in claim 4, characterized in that the flat plate (11) is provided with three side walls (16-18) two of which extending in parallel to each other and substantially perpendicularly to the pivot axis defined by the mounting means (23).

6. The SIM card reading device as claimed in claim 4, characterized in that the holding elements are formed by hooks (20-22) attached to the side walls (16-18).

7. The SIM card reading device as claimed claim 1, characterized in that the mounting means are formed by lobes (23) each provided with a hole (24) to receive a pivot pin (25).

8. The SIM card reading device as claimed in claim 7, characterized in that the holes (24) of the lobes (23) are arranged in such a way the pivot axis defined thereby when mounted on pivot pins is substantially in alignment with an edge of the plate (11) that is provided with the side wall (16).

9. The SIM card reading device as claimed in claim 1, characterized in that the interlocking means is formed by a snap-fit locking element, in particular a snap-hook (30) that is biased by spring element (26) into an intermediate locking position.

10. The SIM card reading device as claimed in claim 9, characterized in that the spring element (26) is arranged substantially perpendicularly to the plate at the side opposite to that adjacent to the pivot axis.

11. The SIM card reading device as claimed in claim 9, characterized in that the snap-hook (30) can be moved against the force of the spring element (26) from is intermediate locking position into a blocked locking position located remote from the plate (11) and into a releasing position located adjacent to the plate (11).

12. The SIM card reading device as claimed in claim 9, characterized in that the snap-hook (30) is provided with a tab (31) for moving it into its releasing position.
